(19) United States
(12) Patent Application Publication
(10) Pub. No.: US 2015/0314963 A1
(43) Pub. Date: Nov. 5, 2015

(54) CHAIN CONVEYOR DEVICE

(71) Applicant: SCHENCK PROCESS LIMITED, Lakeside, Doncaster (GB)

(72) Inventors: Harry CHU, Hong Kong (CN); Dave KENT, Lakeside (GB)

(73) Assignee: Schenck Process UK Limited, Lakeside, DR (GB)

(21) Appl. No.: 14/647,559

(22) PCT Filed: Nov. 26, 2013
(86) PCT No.: PCT/GB2013/053126

§ 371 Date: May 27, 2015

(30) Foreign Application Priority Data
Nov. 27, 2012 (GB) 1221300.5

(51) Int. Cl. B65G 19/24; B65G 19/08

(52) U.S. Cl. CPC B65G 19/24; B65G 19/08

(57) ABSTRACT

A chain conveyor device for material handling comprising: an endless chain (12) comprising a series of chain links (20), wherein adjacent chain links are connected to each other at a connection location; and a first flight member (30) located on a first lateral side of a chain link (20) and having a first reinforcing member (40) extending into or along the body of the first flight member (30), the first reinforcing member (40) further extending away from the first flight member (30), through the chain link (20) and into or along the body of a second flight member (32) located on a second opposite lateral side of the chain link

The present invention relates to an improved chain conveyor device. In particular, but not exclusively, the invention relates to chain conveyor devices with improved load distribution and a reduced volume of material.

A conveyor system is used as material handling equipment in many different industries. A common type of conveyor device is a chain conveyor which comprises an endless chain arrangement. Attached to the chain are a number of flights which push, pull or carry the load to be conveyed.

Known chain conveyors typically comprise a series of chain links, with adjacent chain links connected to each other by a connecting pin held in place by circlips, and a metal flight extending from each side of the chain link. A sleeve may be inserted over the metal flight. However, the profile of the sleeve is limited by the substantial size of the flight.

In many cases, the flights are attached by welding and are located separate and spaced from the connection of adjacent chain links. In other cases, the connection of adjacent chain links (the connecting pin and pin apertures of the chain links) are used to connect the flights. A flight is bolted to each side of the chain link using the pin aperture of the chain link and the connecting pin as the bolt.

The flights conveying the material carry much of the load of the system, although this loading is transmitted to the connecting pin as a tensile force. This loading can be complex as there can be frequent changes of direction, both horizontally and vertically. These changes of direction can cause flexing of the entire length of the flights. Fatigue is a common failure mode. The flights may also spring back suddenly to impact and damage nearby equipment or the conveyed material.

Each flight is a cantilever and the loading on the flight generates a moment which can produce a high separating force at the connection to the chain link. It is known that the welded connection represents a common source of failure. Consequently, the failed flight is unable to convey material and/or the sleeve can become separated from the flight.

For devices that use the connection of adjacent chain links to connect the flights, complex loading on the flight can be transmitted to the chain link as a force other than the tensile force. Therefore, the chain link, connecting pin, or the circlips that retain the pin, can fail. Failure at the connection results in catastrophic failure of the entire device.

It is desirable to provide an improved conveyor device which at least mitigates one or more of the above problems. It is desirable to provide an improved conveyor device in which the flight or flights are not provided as cantilevers. It is desirable to provide an improved conveyor device which provides a material weight saving.

According to a first aspect of the present invention there is provided a chain conveyor device for material handling comprising:
an endless chain comprising a series of chain links, wherein adjacent chain links are connected to each other at a connection location; and
a first flight member located on a first lateral side of a chain link and having a first reinforcing member extending into or along the body of the first flight member, the first reinforcing member further extending away from the first flight member, through the chain link and into or along the body of a second flight member located on a second opposite lateral side of the chain link.

The first reinforcing member may pass through the chain link at a location spaced apart from the connection location. Each chain link may have a connecting pin aperture at each end of the chain link to allow connection to two adjacent chain links and the chain link may further include a first reinforcing member aperture located between the two connecting pin apertures.

The diameters of the first reinforcing member and the first reinforcing member aperture may be substantially equal.

The first reinforcing member may extend into the first and second flight members a distance which is substantially less than the length of the first and second flight members. The first reinforcing member may extend into the first and second flight members a distance which is less than half the length of the first and second flight members.

The body of each of the first and second flight members may include a bore for receiving the first reinforcing member. Alternatively, the first and second flight members may include means for coupling the first reinforcing member to the first and second flight members along at least a portion of their length. The coupling means may comprise fastening means for fastening the first reinforcing member to an exterior surface of the first and second flight members.

The diameters of the first reinforcing member and the bore may be substantially equal.

The first and second flight members may be formed from a plastic or composite material or the like. The first and second flight members may be formed by moulding.

The cross sectional profile of the first and second flight members may include a thickened portion to accommodate the bore for the first reinforcing member. The profile may include one or more portions thinner than the bore diameter. The thickness of each flight member may taper down towards each lateral edge of the flight member. Such a profile provides good load bearing while reducing weight and the amount of material used.

At least one of the first and second flight members may include a shield portion which extends from a major plane of the flight member towards a connection location. The shield portion may be adjacent to the chain link. The shield portion may include a recess for receiving and retaining the connecting pin that connects two adjacent chain links. Such an arrangement provides better retention of the connecting pin and avoids the requirement for circlips. Also, the body of the flight member is thicker at its base to resist bending moments.

The first reinforcing member may be formed from a rigid material such as steel, particularly forged steel. The first reinforcing member may be cylindrical.

The first flight member may include a second reinforcing member extending into the body of the first flight member and further extending away from the first flight member, through the chain link and into the body of the second flight member.

The chain link may further include a second reinforcing member aperture located between the two connecting pin apertures.

The first and second flight members may include a second bore for the second reinforcing member. The first and second flight members may include a second thickened portion to accommodate the second bore.

According to a second aspect of the present invention there is provided a method of assembling a chain conveyor device for material handling, the method comprising:
providing an endless chain comprising a series of chain links, wherein adjacent chain links are connected to each other at a connection location;
inserting a first reinforcing member into a first flight member such that the first reinforcing member extends into the body of the first flight member and a first portion of the first reinforcing member aperture extends away from the first flight member;
passing the first portion of the first reinforcing member through the chain link so that the first flight member is located on a first lateral side of a chain link and such that a second portion extends away from a second opposite lateral side of the chain link; and
inserting the second portion of the first reinforcing member into a second flight member such that the first reinforcing member extends into the body of the second flight member and such that the second flight member is located on a second opposite lateral side of the chain link.

The method may include passing the first reinforcing member through the chain link at a location spaced apart from the connection location.

The method may include forming the diameters of the first reinforcing member and the first reinforcing member aperture to be substantially equal.

The method may include forming the diameters of the first reinforcing member and the bore to be substantially equal.

The method may include retaining the first reinforcing member within one or both of the first reinforcing member aperture and the bore by an interference fit.

The method may include inserting the first reinforcing member into the first and second flight members by a distance which is less than half the length of the first and second flight members.

The method may include forming the first and second flight members from a plastic or composite material or the like. The first and second flight members may be formed by moulding.

The method may include forming at least one of the first and second flight members to include a shield portion which extends from a major plane of the flight member towards a connection location. The method may include forming the shield portion to include a recess for receiving and retaining the connecting pin that connects two adjacent chain links.

Embodiments of the present invention will now be described, by way of example only, with reference to the accompanying drawings in which:

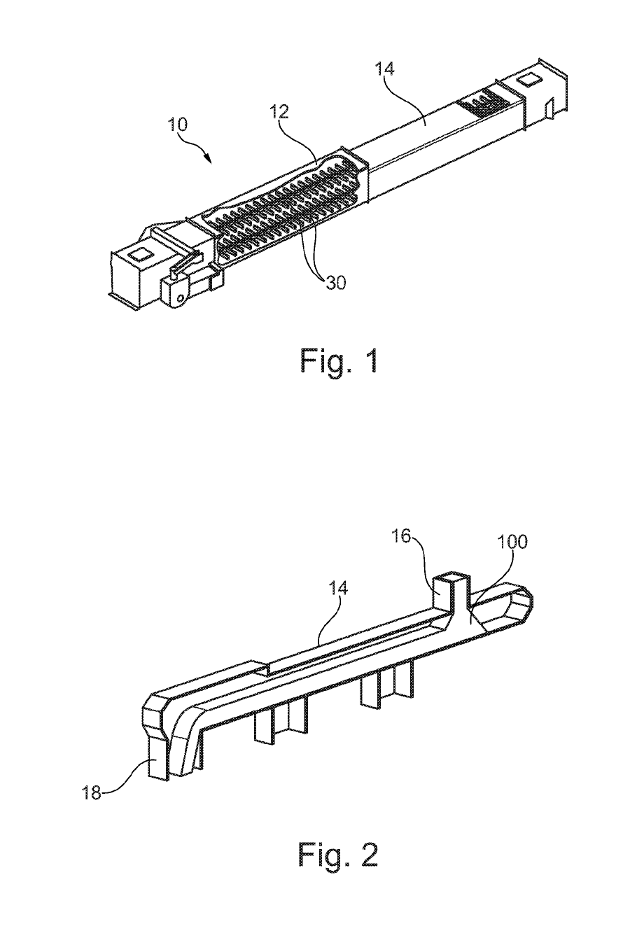

FIG. 1 is a perspective view of a chain conveyor device 10 for material handling;

FIG. 2 is a perspective view of the housing of the chain conveyor device 10 and showing the movement of material;

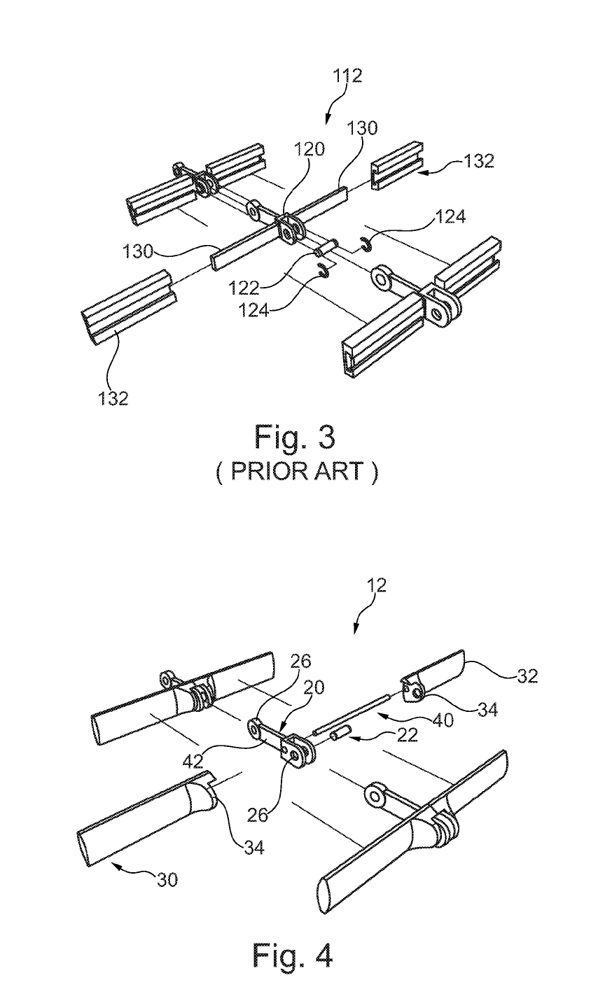

FIG. 3 is an exploded perspective view of a portion of a prior art chain and flights;

FIG. 4 is an exploded perspective view of a portion of a prior art chain and flights according to a first embodiment of the invention;

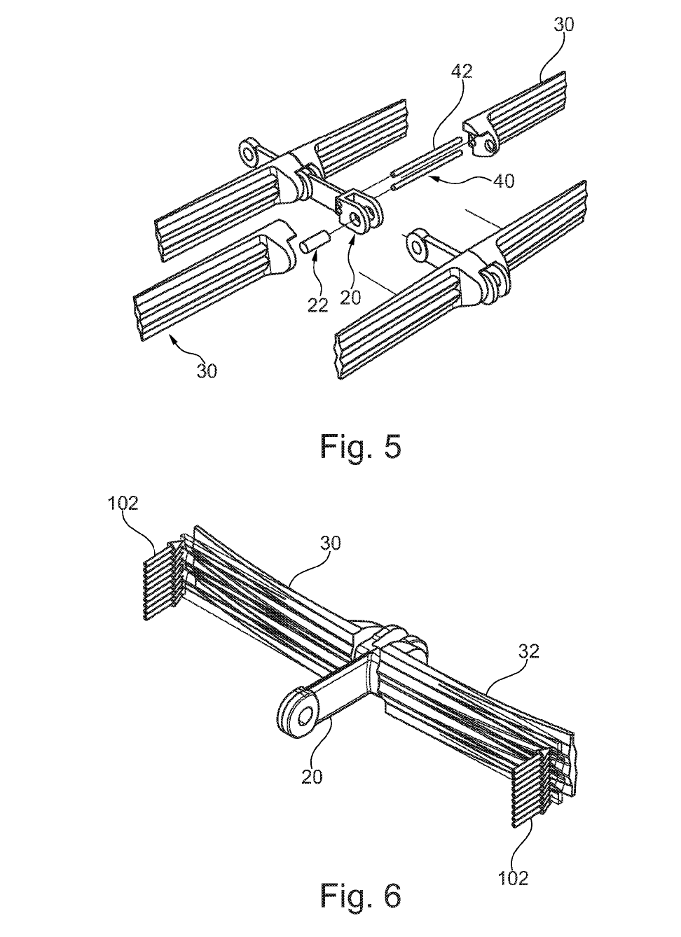

FIG. 5 is an exploded perspective view of a portion of a prior art chain and flights according to a second embodiment of the invention;

FIG. 6 is a perspective view of an FEA model of the portion of chain and flights of the embodiment of FIG. 5;

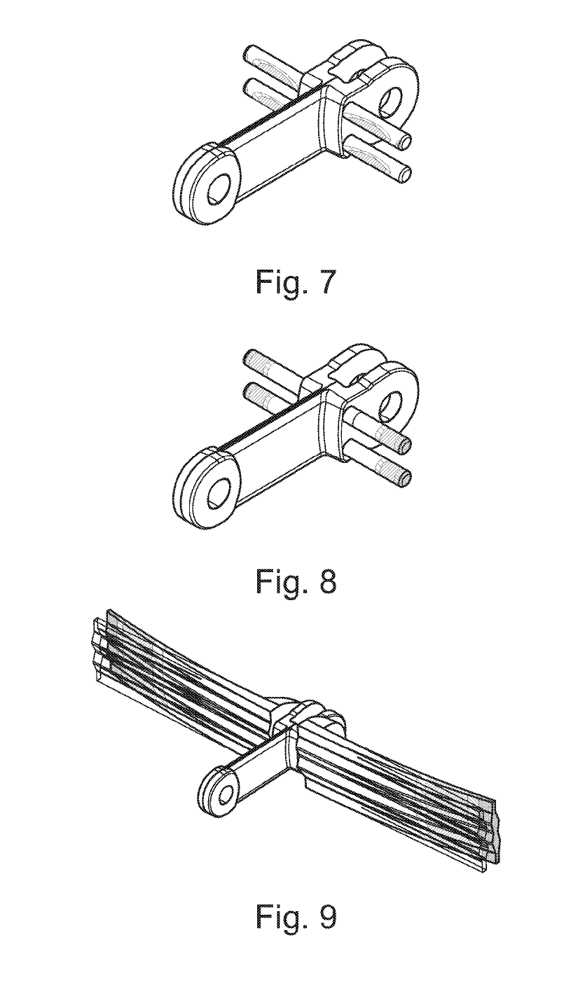

FIG. 7 is a perspective view of the stress results from the FEA model of FIG. 6 for the chain link and reinforcing members in isolation;

FIG. 8 is a perspective view of the deflection results from the FEA model of FIG. 6 for the chain link and reinforcing members in isolation; and

FIG. 9 is a perspective view of the deflection results from the FEA model of FIG. 6 for the chain link, reinforcing members and flights.

FIG. 1 shows a chain conveyor device 10 for material handling. The device 10 comprises an endless chain 12 formed by a series of connected chain links 20 and an arrangement of flights 30 connected to the chain links 20 for moving the material 100. The chain 12 and connected flights 30 are provided within a housing 14. The housing 14 includes an inlet 16 for receiving material 100 at a first location and an outlet 18 for discharging the material 100 at a second location. This movement of material 100 is shown in FIG. 2.

FIG. 3 shows a portion of a prior art chain 112 with connected flights 130. The chain 112 comprise a series of chain links 120, with adjacent chain links connected to each other by a connecting pin 122 held in place by circlips 124. A metal flight 130 is welded to each side of the chain link 120. A sleeve 132 is inserted over the metal flight.

FIG. 4 shows a portion of a chain 12 and flights 130 according to a first embodiment of the invention. As with the known arrangement, the chain 12 comprise a series of chain links 20, and adjacent chain links 20 are connected to each other by a connecting pin 22. A first flight 30 is positioned at a first side of the chain link 120 and a second flight 32 is positioned at a second side of the chain link 120.

However, rather than using welding (or the connection point 26 for adjacent chain links) a first reinforcing member 40 extends into the body of the first flight 30. The first reinforcing member 40 further extends away from the first flight 30, through the chain link 20 and into the body of the second flight 32. The first reinforcing member 40 is formed from a strong, stiff and tough material, for example forged steel. However, other forms of steel, including extruded steel, stainless steel, high tensile rolled steel, coiled spring steel, and non-steel materials could also be used.

Therefore, rather than being a cantilever like the prior art flights, the first reinforcing member 40 will experience only bending stresses in operation.

The first reinforcing member 40 passes through a separate aperture 42 provided at the chain link 20. This aperture 42 is at a location spaced apart from, and in between, the two connection locations 26 for adjacent chain links 20. Therefore, any loading on the flights 30 is not directly transmitted to the connecting pin 22. Also, the diameters of the first reinforcing member 40 and the aperture 42 are substantially equal so there is little or no clearance or play. This prevents or minimises any deviation of the first reinforcing member 40 from an axis normal to the plane of the aperture 42, and also assists in distributing loading.

Also, it can be seen that the arrangement according to the invention does not include any circlips 124. This is due to the profile of the flights 30 as explained below.

The flights 30 are plastic and formed by moulding. This allows greater flexibility in the cross sectional profile of the flights 30. In the embodiment of FIG. 4, the thickness of each flight reduces towards each lateral edge of the flight 30. Such a profile provides good load bearing while reducing weight and the amount of material used.

A bore is formed in each flight 30 during moulding. The first reinforcing member 40 extends into a bore of the flights 30 for a distance which is around a third of the length of the flights. The diameters of the first reinforcing member 40 and the bores are substantially equal and the flights are connected to the first reinforcing member 40 using an interference fit.

During moulding, the flights are formed with a shield portion 34. This portion extends from a major plane of the flights 30 towards the connection location 26 and adjacent to the chain link 20. The shield portion 34 includes a recess for receiving and retaining the connecting pin 22. This arrangement provides better retention of the connecting pin 22 and avoids the requirement for circlips. Also, the body of the flight 30 is thicker at its base to resist bending moments.

FIG. 5 shows a portion of a chain 12 and flights according to a second embodiment of the invention and like features are given like reference numerals.

In this embodiment, there are two reinforcing members for increased strength and rigidity. The flights 30 are moulded with a second bore and the chain link 20 includes a second aperture for receiving the second reinforcing member 42.

Also, in this embodiment, the flights have a modified profile. Each flight includes a thickened portion to accommodate each bore, as well as thinner portions. This geometry provides good bending strength while minimising on the amount of material used.

It has been found that the arrangement according to the invention provides excellent performance in terms of distribution of loading and stresses, greater rigidity and greater strength (withstanding a higher load before failure). This has been verified using Finite Element Analysis (FEA).

For instance, FIG. 6 shows an FEA model of the portion of the chain 12 and flights of the embodiment of FIG. 5. In the model, the applied load 102 represents the loading that the flights would experience when pushing the material 100. The flights experience bending and the bending deflection increases towards the free end of each flight.

This deflection is useful as it helps to accommodate changes of direction of the conveyor system and absorbs energy. A more rigid structure would experience greater stress at the chain link 20. This is why the first reinforcing member 40 only extends into the flights for about a third of the length of the flights. However, the plastic material can be selected with properties that do not result in rapid spring back when the load is removed.

FIG. 7 shows the Von Mises stress results from the FEA model of FIG. 6 for the chain link 20 and reinforcing members 40 in isolation. It can be seen that the stress is evenly distributed with no local stress concentrations.

FIGS. 8 and 9 show the deflection results from the FEA model of FIG. 6 for the chain link 20 and reinforcing members 40 in isolation and with the flights respectively. The deflection progressively increases as the distance from the chain link 20 increases.

The invention provides a number of advantages. For example, as well as improved load distribution, the type and amount of materials used result in weight savings. Depending on the chain length involved (a typical range is from 10 m to 40 m), there is a significant 33% to 40% weight saving. As the chain weight is reduced, less power is required to convey both the chain and material. This improves the mechanical efficiency of the chain conveyor device.

The invention also provides material and manufacturing cost savings due, for example, to improved ease of manufacturing and a reduction in the number of parts.

Whilst specific embodiments of the present invention have been described above, it will be appreciated that departures from the described embodiments may still fall within the scope of the present invention.

1.-28. (canceled)

29. A chain conveyor device for material handling comprising:
an endless chain comprising a series of chain links, wherein adjacent chain links are connected to each other at a connection location; and
a first flight member located on a first lateral side of a chain link and having a first reinforcing member extending into or along the body of the first flight member, the first reinforcing member further extending away from the first flight member, through the chain link and into or along the body of a second flight member located on a second opposite lateral side of the chain link.

30. A device as claimed in claim 29, wherein the first reinforcing member passes through the chain link at a location spaced apart from the connection location; and optionally wherein the chain link has a connecting pin aperture at each end of the chain link to allow connection to two adjacent chain links, and wherein the chain link further includes a first reinforcing member aperture located between the two connecting pin apertures.

31. A device as claimed in claim 29, wherein the diameters of the first reinforcing member and the first reinforcing member aperture are substantially equal; and optionally wherein the first reinforcing member extends into or along the first and second flight members a distance which is substantially less than the length of the first and second flight members; and optionally wherein the first reinforcing member extends into or along the first and second flight members a distance which is less than half the length of the first and second flight members.

32. A device as claimed in claim 29, wherein the body of each of the first and second flight members includes a bore for receiving the first reinforcing member; and
optionally wherein the diameters of the first reinforcing member and the bore are substantially equal.

33. A device as claimed in claim 29, wherein the first and second flight members are formed from a plastic or composite material; and optionally wherein the first and second flight members are formed by moulding.

34. A device as claimed in claim 32, wherein the cross sectional profile of the first and second flight members includes a thickened portion to accommodate the bore for the first reinforcing member.

35. A device as claimed in claim 32, wherein the profiled includes one or more portions thinner than the bore diameter.

36. A device as claimed in claim 29, wherein the thickness of each flight member tapers down towards each lateral edge of the flight member.

37. A device as claimed in claim 29, wherein at least one of the first and second flight members includes a shield portion which extends from a major plane of the flight member towards a connection location; and optionally wherein the shield portion is adjacent to the chain link.

38. A device as claimed in claim 29, wherein the first flight member includes a second reinforcing member extending into the body of the first flight member and further extending away from the first flight member, through the chain link and into the body of the second flight member; and optionally wherein the chain link includes a second reinforcing member aperture located between the two connecting pin apertures; and optionally wherein the first and second flight members include a second bore for the second reinforcing member.

39. A method of assembling a chain conveyor device for material handling, the method comprising:
providing an endless chain comprising a series of chain links, wherein adjacent chain links are connected to each other at a connection location;
inserting a first reinforcing member into a first flight member such that the first reinforcing member extends into the body of the first flight member and a first portion of the first reinforcing member aperture extends away from the first flight member;
passing the first portion of the first reinforcing member through the chain link so that the first flight member is located on a first lateral side of a chain link and such that a second portion extends away from a second opposite lateral side of the chain link; and
inserting the second portion of the first reinforcing member into a second flight member such that the first reinforcing member extends into the body of the second flight member and such that the second flight member is located on a second opposite lateral side of the chain link.

40. A method as claimed in claim 39, including passing the first reinforcing member through the chain link at a location spaced apart from the connection location; optionally including forming a bore at the first and second flight members and forming a first reinforcing member aperture at the chain link, both for receiving the first reinforcing member; and optionally including forming the diameters of the first reinforcing member and the first reinforcing member aperture to be substantially equal.

41. A method as claimed in claim 40, including retaining the first reinforcing member within one or both of the first reinforcing member aperture and the bore by an interference fit; and optionally including inserting the first reinforcing member into the first and second flight members by a distance which is less than half the length of the first and second flight members.

42. A method as claimed in claim 39, including forming the first and second flight members from a plastic or composite material.

43. A method as claimed in claim 39, including forming at least one of the first and second flight members to include a shield portion which extends from a major plane of the flight member towards a connection location; and optionally including forming the shield portion to include a recess for receiving and retaining the connecting pin that connects two adjacent chain links.
